(19) United States
(12) Patent Application Publication
(10) Pub. No.: US 2005/0058112 A1
(43) Pub. Date: Mar. 17, 2005

(54) Method of and apparatus for adaptively managing connectivity for mobile devices through available interfaces

(75) Inventors: Kevin Lahey, Mountain View, CA (US); Atsushi Shionozaki, Sunnyvale, CA (US); Pierre Guillaume Raverdy, Santa Clara, CA (US); Yoshifumi Nishida, Sunnyvale, CA (US)

Correspondence Address: HAVERSTOCK & OWENS LLP, 162 NORTH WOLFE ROAD, SUNNYVALE, CA, 94086, US

(73) Assignees: Sony Corporation; Sony Electronics Inc

(21) Appl. No.: 10/663,166

(22) Filed: Sep. 15, 2003

(51) Int. Cl. H04Q 7/24

(52) U.S. Cl. 370/338; 370/328; 370/252; 370/332; 455/525

(57) ABSTRACT

A method of and apparatus for adaptively managing connectivity for mobile devices through available interfaces allows a user to seamlessly move from one access point to another while the user's mobile device manages the connection for the user. The user's mobile device continuously probes for access points, identifies access points within range of the device and chooses to connect to the access point that fits defined criteria. Information within the access point's beacon signal is used to obtain information regarding the access point and the characteristics of service provided by the access point through out of band communications. Preferably, the mobile device utilizes a separate IPv6 address for each application used by the mobile device so that communications are associated with the appropriate application utilizing this address.

### FIELD OF THE INVENTION

The present invention relates to the field of determining connectivity services available to a mobile device. More particularly, the present invention relates to the field of determining available connectivity services and managing a connection for a mobile device.

### BACKGROUND OF THE INVENTION

Traditionally users have accessed the internet from computers in fixed locations, such as the home or office. With recent advances in computer hardware and wireless communications, an increasing number of users are using the internet from small, wireless, devices such as laptops and cell phones from almost any location. There are many standards and technologies available for accessing the internet from various locations. One technology for wirelessly accessing the internet is specified by the IEEE 802.11b communications standard, which is otherwise known as Wi-Fi. This communications standard is the wireless equivalent of the Ethernet protocol, specified by the IEEE 802.3 communications standard.

The IEEE 802.11b communications standard defines the physical layer and media access control (MAC) sublayer for communications across a shared, wireless local area network (WLAN). At the physical layer, IEEE 802.11b operates at the radio frequency of 2.45 gigahertz with a maximum bit rate of 11 Mbps. Wi-Fi uses the direct sequence spread spectrum (DSSS) transmission technique. At the MAC sublayer of the data link layer, Wi-Fi uses the carrier sense multiple access with collision avoidance (CSMA/CA) media access control (MAC) protocol.

An alternative to IEEE 802.11b, the IEEE 802.11a communications standard is an extension to the IEEE 802.11 standard. The IEEE 802.11a standard applies to wireless local area networks and operates at a frequency of 5 gigahertz with rates up to 54 Mbps, using orthogonal frequency division multiplexing (OFDM). Because of the higher operating frequency used by IEEE 802.11a, the available signal range of approximately 60 feet is shorter than the range typically available with IEEE 802.11b.

A further alternative to IEEE 802.11b, the IEEE 802.11 g communications standard is an extension to the IEEE 802.11 standard. The IEEE 802.11 g standard applies to wireless local area networks and operates at a frequency of 2.4 gigahertz with rates up to 54 Mbps. Because the 802.11 g standard also operates at a frequency of 2.4 gigahertz, it is compatible with the IEEE 802.11b standard.

A wireless station with a frame to transmit first listens on the wireless medium to determine if another station is currently transmitting. If the medium is being used, the wireless station calculates a random backoff delay. Only after the random backoff delay elapses can the wireless station again listen for a transmitting station. By instituting a random backoff delay, multiple stations that are waiting to transmit do not end up trying to transmit at the same time.

Within a Wi-Fi network, a station is a network node that is equipped with a wireless network device. A personal computer with a wireless network adapter is known as a wireless client. Wireless clients can communicate directly with each other or through a wireless access point. Wireless clients are mobile.

A wireless access point is a wireless network node that acts as a bridge between stations and a network. A wireless access point contains at least one interface that connects the wireless access point to an existing network, such as an ethernet backbone, a wireless network device with which it generates wireless connections with stations and bridging software, so that the wireless access point can act as a transparent bridge between the wireless and existing networks. A wireless access point is similar to a cellular phone network's base station. Wireless clients communicate with both the existing network and other wireless clients through the wireless access point. Wireless access points act as peripheral bridge devices that extend a network.

Within a wireless network, a port is a channel of a device that can support a single point-to-point connection. A port is an association, which provides a logical entity over which a single wireless connection is made. A typical wireless client with a single wireless network adapter has one port and can support only one wireless connection. A typical wireless access point has multiple ports and can simultaneously support multiple wireless connections. The logical connection between a port on the wireless client and the port on a wireless access point is a point-to-point bridged local area network segment, similar to an ethernet-based network client that is connected to an ethernet switch.

The IEEE 802.11 standard defines an ad hoc mode and an infrastructure mode. In the ad hoc mode, also known as peer-to-peer mode, wireless clients communicate directly with each other, without the use of a wireless access point. Two or more wireless clients who communicate using ad hoc mode form an independent basic service set. Ad hoc mode is used to connect wireless clients when a wireless access point is not present.

In the infrastructure mode, there is at least one wireless access point and one wireless client. The wireless client uses the wireless access point to access the resources of a network. The network can be an organization intranet or the Internet, depending on the placement of the wireless access point.

A single wireless access point that supports one or multiple wireless clients is known as a basic service set. A set of two or more wireless access points that are connected to the same network is known as an extended service set. An extended service set is a single logical network segment, also known as a subnet, and is identified by its service set identifier. If the available physical areas of the wireless access points in an extended service set overlap, then a wireless client can roam, or move from one location, with a wireless access point, to another, with a different wireless access point, while maintaining network layer connectivity.

Each wireless access point periodically sends out a beacon signal to notify wireless clients within the range of the signal of the availability of the wireless access point. The beacon signal includes information from which the signal strength of the access point is determined, the speeds at which the access point is able to communicate, a 32-octet service set identifier (SSID) and a six octet media access control (MAC) address.

When a wireless adapter is turned on, it begins to scan across the wireless frequencies for wireless access points and other wireless clients in the ad hoc mode. Assuming that the wireless client is configured to operate in the infrastructure mode, the wireless adapter chooses a wireless access point with which to connect. This selection is made automatically by using a service set identifier and signal strength and frame error rate information. Next, the wireless adapter switches to the assigned channel of the selected wireless access point and negotiates the use of a port. This is known as establishing an association.

If the signal strength of the wireless access point with which an association is established, is too low, the error rate is too high, or if instructed by the operating system, the wireless adapter scans for other wireless access points to determine whether a different wireless access point can provide a stronger signal or lower error rate. If such a wireless access point is located, the wireless adapter switches to the channel of that wireless access point and negotiates the use of a port. This is known as reassociation with a different wireless access point and can occur for several reasons. The signal can weaken as either the wireless adapter moves away from the wireless access point or the wireless access point becomes congested with too much traffic or interference. By switching to another wireless access point, the wireless adapter can distribute the load to other wireless access points, increasing the performance for other wireless clients. Contiguous coverage over large areas can be achieved by placing wireless access points so that their signal areas slightly overlap. As a wireless client roams across different signal areas, it can associate and reassociate from one wireless access point to another wireless access point, maintaining a continuous logical connection to the network.

To use Wi-Fi, a user is required to have a Wi-Fi transceiver installed in an access device, such as a laptop or personal digital assistant (PDA). Wi-Fi access is provided by base stations or access points. An individual access point can service many Wi-Fi users and usually has a range of approximately 300 feet, although this number is growing as the technology improves. In fact, some access point devices have a range of several miles. Most industry observers agree that within three to five years, most public areas within the United States will be fully covered with Wi-Fi access.

Conventionally, mobile systems have been developed and designed by the companies that own the infrastructure, such as the service providers. Current cellular telephone networks function this way, where the mobile cellular telephone terminals are not equipped with any intelligence and are forced to attach to base stations or roam to a specific provider. The mobile cellular telephone terminal does not have the flexibility of choosing the next hop or cell of the network or service to roam to according to its needs.

Mobile devices are now being equipped with the capability to communicate using multiple network access technologies. For example, current laptop computer systems are being equipped with internal IEEE 802.11b and internal ethernet capability. Other laptop computer systems are being equipped with internal IEEE 802.11b and IEEE 802.11a capability.

Currently, the infrastructure in place or a particular service provider determines how a particular user or device obtains access to a service. In such a heterogeneous environment, it cannot be assumed that the infrastructure or a service provider will make the best decision on behalf of a mobile user or a device, as to the best available service or connection to a service. This is because the next hop or cell can possibly present multiple choices of different wireless access types, provided by different service providers, with different characteristics.

In other situations, when a particular service provider's coverage does not extend into an area currently being used by a user, the user must switch to a different provider providing service within that area. Conventionally, this has been automatically handled through a roaming agreement between the two providers. Roaming support may not be easily deployed because of business, financial, political or even technical issues. The user or the mobile device has not conventionally been involved in such decisions nor even had the opportunity to participate in these connection decisions.

As the use of wireless networks grow, these networks will become decentralized. One scenario includes large internet service providers providing coverage over major urban areas with many access points and smaller internet service providers deploying access points for specific purposes. In this scenario, the large internet service providers provide coverage in the major urban areas similar to the cellular networks, so that users could have nearly seamless connectivity as they move around the area. The smaller internet service providers are sites such as coffee shops, who provide connectivity through one or more local access points to attract customers or music stores, who allow customers to wirelessly download music or previews of music through an access point within the store.

Each of these service providers have different characteristics, such as speed of the uplink connection between the access point and the internet, bandwidth and cost. The large internet service providers might allow as much bandwidth as the wireless network could provide, while the music store provides minimal uplink bandwidth, but offers a large cache of local content available to users. The music store might also allow free access, while the large internet service provider typically charges by the megabyte of downloaded data, by time or by some flat subscription rate.

A user currently has no ability to determine the different characteristics of the available services and make an informed decision as to which access point and service should be used.

### SUMMARY OF THE INVENTION

A method of and apparatus for adaptively managing connectivity for mobile devices through available interfaces allows a user to seamlessly move from one access point to another while the user's mobile device manages the connection for the user. The user's mobile device continuously probes for access points, identifies access points within range of the device and chooses to connect to the access point that fits defined criteria. Information within the access point's beacon signal is used to obtain information regarding the access point and the characteristics of service provided by the access point through out of band communications. Preferably, the mobile device utilizes a separate IPv6 address for each application used by the mobile device so that communications are associated with the appropriate interface utilizing this address. The method of and apparatus for the present invention is useful in any network configuration with access points that send a beacon signal, including any 802.11 network configuration complying with one or more current or future 802.11 standards.

In one aspect of the present invention, a method of adaptively managing connectivity for a mobile device comprises obtaining a signal from each access point available to the mobile device, wherein the signal includes source information and obtaining characteristic information about each access point and characteristics of service provided by the access point using the source information. The signal is preferably a beacon signal. The method further comprises comparing the characteristic information to determine a preferred access point. The preferred access point is an access point which most closely matches criteria. The source information includes an address and is resident within an SSID of the beacon signal. The address is either a URL address or an IPv6 address. Alternatively, the source information includes the characteristic information. The method further comprises associating a separate IPv6 address for communications relative to each separate application used by the mobile device. The method further comprises associating a separate IPv6 address for communications relative to each separate application used with each separate connection by the mobile device. The characteristic information is obtained for an access point without forming a connection to the access point. An access point is available if the mobile device is within a range to communicate with the access point. The characteristics of service include one or more of bandwidth, speed and cost.

In another aspect of the present invention, a method of adaptively managing connectivity for a mobile device comprises managing communications for the mobile device using a plurality of applications and associating a separate IPv6 address for communications relative to each separate application. The method further comprises sending communications from the mobile device through one of a plurality of interfaces based on the separate IPv6 address and corresponding application. The method further comprises receiving communications at the mobile device through one of a plurality of interfaces based on the separate IPv6 address and corresponding application. The method further comprises obtaining a beacon signal from each access point available to the mobile device, wherein the beacon signal includes source information, obtaining characteristic information about each access point and characteristics of service provided by the access point using the source information, determining a preferred access point by comparing the characteristic information to criteria and determining the access point which most closely matches the criteria and establishing a connection with the preferred access point.

In yet another aspect of the present invention, a method of adaptively managing connectivity for a mobile device comprises obtaining a beacon signal from each access point available to the mobile device, wherein the beacon signal includes source information, obtaining characteristic information about each access point and characteristics of service provided by the access point using the source information and determining a preferred access point by comparing the characteristic information to criteria and determining the access point which most closely matches the criteria. The method further comprises establishing a connection with the preferred access point. The is preferably established using communications complying with an IEEE 802.11 standard. The source information includes an address and is resident within an SSID of the beacon signal. The address is either a URL address or an IPv6 address. Alternatively, the source information includes the characteristic information. An access point is available if the mobile device is within a range to communicate with the access point. The characteristics of service include one or more of bandwidth, speed and cost. The characteristic information is obtained for an access point without forming a connection to the access point. The method further comprises associating a separate IPv6 address for communications relative to each separate application used by the mobile device. Alternatively, the method further comprises associating a separate IPv6 address for communications relative to each separate application used with each separate connection by the mobile device.

In another aspect of the present invention, a network connection manager configured to adaptively manage connectivity for a mobile device, the network connection manager comprises a communications interface configured to receive communications from access points available to the mobile device, the communications including a beacon signal from each available access point, wherein the beacon signal includes source information and a controller coupled to the communications interface to obtain characteristic information about each access point and characteristics of service provided by the access point using the source information. The controller compares the characteristic information to determine a preferred access point. The preferred access point is an access point which most closely matches criteria. The criteria is defined by a user. The source information includes an address and is resident within an SSID of the beacon signal. The address is either a URL address or an IPv6 address. Alternatively, the source information includes the characteristic information. The characteristic information is obtained for an access point without forming a connection to the access point. An access point is available if the mobile device is within a range to communicate with the access point. The characteristics of service include one or more of bandwidth, speed and cost. The controller associates a separate IPv6 address for communications relative to each separate application used by the mobile device. Alternatively, the controller associates a separate IPv6 address for communications relative to each separate application used with each separate connection by the mobile device.

In still a further aspect of the present invention, a network connection manager for adaptively managing connectivity for a mobile device comprises means for interfacing for receiving communications from access point available to the mobile device, the communications including a beacon signal from each available access point, wherein the beacon signal includes source information and means for controlling coupled to the means for interfacing for obtaining characteristic information about each access point and characteristics of service provided by the access point using the source information. The means for controlling compares the characteristic information to determine a preferred access point. The preferred access point is an access point which most closely matches criteria. The criteria is defined by a user. The source information includes an address and is resident within an SSID of the beacon signal. The address is a URL address or an IPv6 address. The source information includes the characteristic information. The characteristic information is obtained for an access point without forming a connection to the access point. An access point is available if the mobile device is within a range to communicate with the access point. The characteristics of service include one or more of bandwidth, speed and cost. The means for controlling associates a separate IPv6 address for communications relative to each separate application used by the mobile device. The means for controlling associates a separate IPv6 address for communications relative to each separate application used with each separate connection by the mobile device.

In another aspect of the present invention, a network connection manager configured to adaptively manage connectivity for a mobile device, the network connection manager comprises a plurality of interfaces each configured to send and receive communications for one of a plurality of applications used by the mobile device and a controller coupled to the plurality of interfaces to associate a separate IPv6 address for communications relative to each separate application, wherein only communications having an address corresponding to an application and a corresponding interface are sent and received through the interface.

In still another aspect of the present invention, a network of devices comprises a plurality of access points each including a wireless interface through which access point communications are sent and received including a beacon signal having source information and a server interface configured to couple to one or more internet servers to provide internet communications with the servers for devices communicating through the wireless interface, a mobile device configured to communicate with the wireless interface and including a network connection manager which adaptively manages connectivity for the mobile device, the network connection manager comprising a communications interface configured to receive the access point communications and a controller coupled to the communications interface to obtain characteristic information about each access point available to the mobile device and characteristics of service provided by the access points using the source information. The controller compares the characteristic information to determine a preferred access point. The preferred access point is an access point which most closely matches criteria. The criteria is defined by a user. The source information includes an address and is resident within an SSID of the beacon signal. The address is either a URL address or an IPv6 address. The source information includes the characteristic information. The characteristic information is obtained for an access point without forming a connection to the access point. An access point is available if the mobile device is within a range to communicate with the access point. The characteristics of service include one or more of bandwidth, speed and cost. The controller associates a separate IPv6 address for communications relative to each separate application used by the mobile device. Alternatively, the controller associates a separate IPv6 address for communications relative to each separate application used with each separate connection by the mobile device.

### BRIEF DESCRIPTION OF THE DRAWINGS

FIG. 1 illustrates a block diagram of an exemplary wireless network.

FIG. 2 illustrates a block diagram of the internal components of an exemplary user mobile device.

FIG. 3 illustrates an exemplary configuration of access points.

FIG. 4 illustrates a flowchart of the method used by the mobile device of the preferred embodiment of the present invention to manage connectivity.

### DETAILED DESCRIPTION OF THE PREFERRED EMBODIMENT

The connectivity management system of the present invention allows a user to seamlessly move from one access point to another while the user's mobile device manages the connection for the user. As the user travels in and out of range of multiple access points, the user's mobile device seamlessly probes for access points, identifies access points within range of the device and chooses to connect through the access point that fits criteria established by the user or the device. The mobile device thus maintains and manages the connectivity through transitions between access points and service providers, based on the established criteria. This criteria includes an analysis of characteristics of the available services, such as cost, bandwidth and speed. Preferably, the mobile device also tracks and monitors the total utilization by the user. This allows the user to set limits for expenses on connectivity and allows the user to determine at any given time, how much has been spent over a period of time on connectivity. If the service that the mobile device chooses is not acceptable to the user, the user has the ability to change the criteria so that a different service is utilized or override the mobile device and manually choose an available service.

As the user moves through an area, the user's mobile device obtains information about the available access points and services in that area. Forming a connection to an access point to access data through the access point can take a considerable amount of time. Accordingly, there is typically not time to form a connection and obtain information from each access point available within an area having multiple access points. The connectivity management system of the present invention utilizes the beacon signal of the access point to obtain more information about the service available through the access point. This does not require forming a connection with each access point and is herein referred to as an out of band communication. Through this out of band connection, the mobile device is able to quickly obtain the necessary information from each available access point in order to compare the available services and choose the access point that provides the service most closely matching the established criteria, without having to establish a connection with each available access point. The information for each available access point is preferably obtained from an information server associated with the access point. This information includes information about the bandwidth available, the speed available and the cost of data usage through the access point.

Using the connectivity management system of the present invention, the mobile device is capable of sending or receiving data using multiple interfaces. For example, video data can be sent to the mobile device by 802.11a, while audio data is simultaneously being sent to the mobile device by GPRS. In this situation it is necessary to manage each of these data flows so that the data is associated with its specific interface. Preferably, a separate address is used for each application so that communications are associated with the appropriate application utilizing this address. Preferably, the address is an IPv6 address.

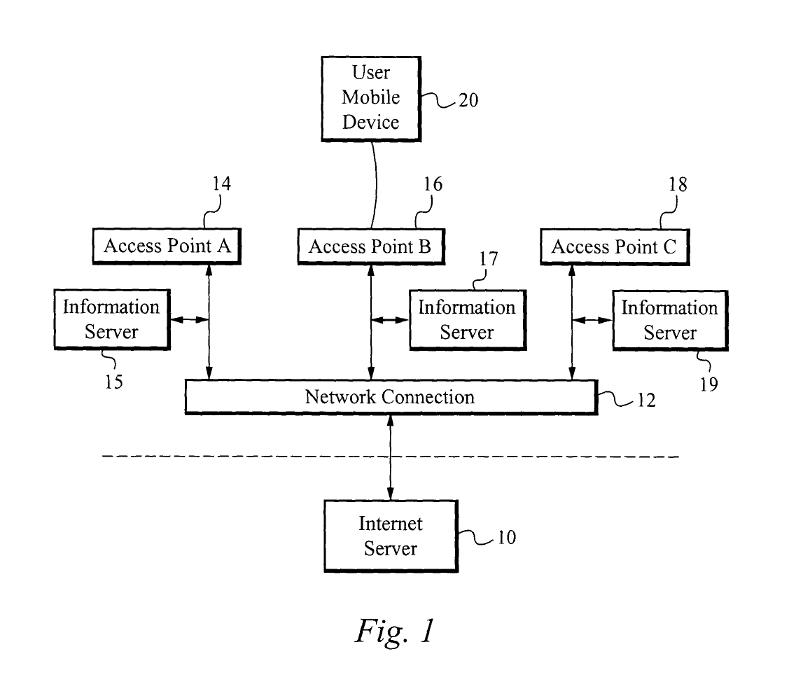

A block diagram of an exemplary wireless network is illustrated in FIG. 1. An internet server 10 is coupled to an internet network connection 12 to allow communications between both the internet server 10 and the access points 14, 16 and 18. This internet network connection can be any appropriate connection which connects the internet server 10 to the internet, including a wired connection such as through the public switched telephone network, cable or other appropriate wired or wireless connection, including a satellite link. The user mobile device 20 communicates with the access points 14, 16 and 18, wirelessly, as described above. In the exemplary network of FIG. 1, the user mobile device 20 gains access to the internet through the Access Point B 16. Each of the access points 14, 16 and 18 are coupled to the internet network connection 12 to allow the user mobile device 20 to access the internet and the internet server 10.

As illustrated in the exemplary network of FIG. 1, the access point 14 has an associated information server 15, the access point 16 has an associated information server 17 and the access point 18 has an associated information server 19. Each of the information servers 15, 17 and 19 are coupled to the network connection 12 for communicating directly or over the internet. Each of the information servers 15, 17 and 19 have an associated URL address and are preferably utilized to provide information regarding the access points 14, 16 and 18 and the characteristics of service provided by the access points 14, 16 and 18. As will be discussed in detail below, a mobile device 20 preferably obtains the URL address of an appropriate one of the information servers 15, 17 and 19, from the beacon signal of the corresponding access point 14, 16 or 18, when the mobile device 20 is within range of the access point. The mobile device then uses this URL address to obtain information about the access point and the characteristics of the service provided by the access point. Using this information, the mobile device is then able to make an informed comparison and decision as to with which available access point a connection should be established. It should be apparent to those skilled in the art that the information server associated with an access point can be located anywhere as long as the information server can be accessed using the address. It should also be apparent that alternatively a single information server can include information for multiple access points.

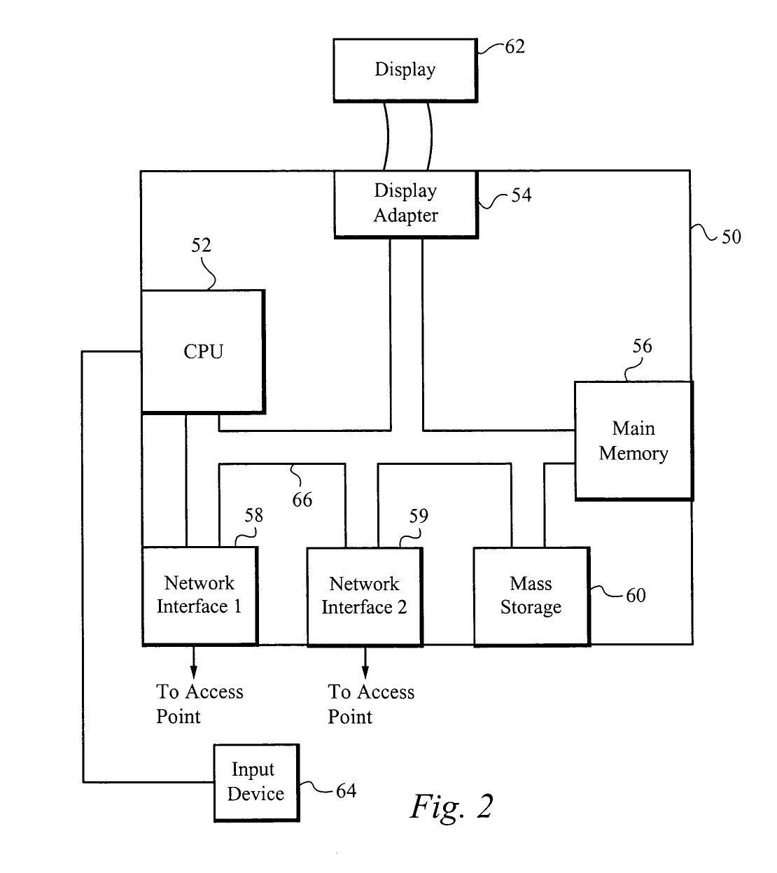

A block diagram of the internal components of a user mobile device used by users to access the internet server 10 of the present invention is illustrated in FIG. 2. While any appropriately configured computer system or mobile device can be used to implement the network connection manager of the present invention, an exemplary computer system 50 for accessing the internet server 10 is illustrated in FIG. 2. The exemplary computer system 50 includes a CPU 52, a main memory 56, a display adapter 54, a mass storage device 60, a first network interface 58 and a second network interface 59, all coupled together by a conventional bidirectional system bus 66. The first network interface 58 preferably operates according to a first communications standard such as an IEEE 802.11 standard and wirelessly accesses available wireless access points. The first network interface 58 can be any appropriate device for sending and receiving communications according to the first communications standard, such as a card or circuit. The second network interface 59 preferably operates according to a second communications standard, different than the first communications standard. The second communications interface 59 can be any appropriate device for sending and receiving communications according to the second communications standard, such as a card or circuit. Alternatively, any other appropriate connection interface can be used including any interface compatible with one or more current or future 802.11 standards or a wired connection. In a further embodiment, any number of interfaces are included within the user mobile device, as appropriate, including one or more interfaces. The mass storage device 60 may include both fixed and removable media using any one or more of magnetic, optical or magneto-optical storage technology or any other available mass storage technology. The system bus 66 contains an address bus for addressing any portion of the memory 56 and 60. The system bus 66 also includes a data bus for transferring data between and among the CPU 52, the main memory 56, the display adapter 54, the mass storage device 60, the first network interface 58 and the second network interface 59.

The computer system 50 is also coupled to a number of peripheral input and output devices including the input device 64 and the associated display 62. The input device 64 may be any appropriate input device including keyboard, mouse, touch screen or stylus.

The display adapter 54 interfaces between the components within the computer system 50 and the display 62. The display adapter 54 converts data received from the components within the computer system 50 into signals which are used by the display 62 to generate images for display.

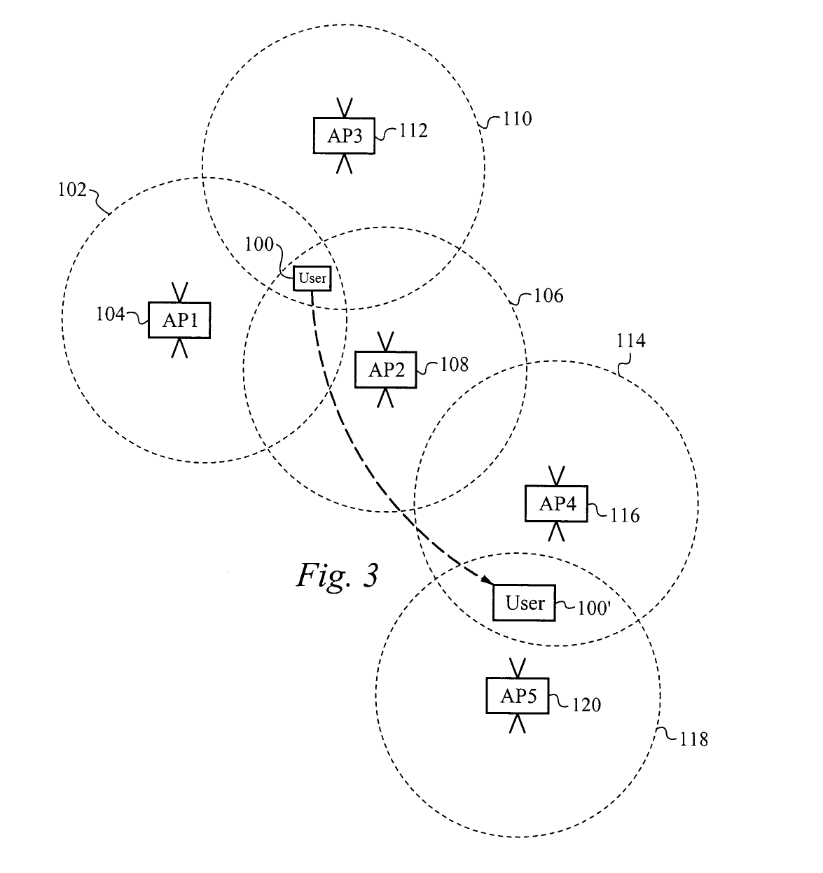

An exemplary configuration of access points is illustrated in FIG. 3. Each of the access points 104, 108, 112, 116 and 120 have an associated range 102, 106, 110, 114 and 118, as shown in dotted lines in FIG. 3. Within the exemplary configuration of FIG. 3, the access points 104, 108 and 112 are all visible to the user in an original position 100. As the user travels to a second position 100′, the access points 116 and 120 are then visible to the user.

When the user is at the position 100, the user's mobile device obtains beacon signals from each of the access points 104, 108 and 112. Using information from these beacon signals, as will be discussed in detail below, the mobile device then obtains information regarding the access point and the characteristics of the service provided by each of the access points 104, 108 and 112. From this obtained information, the mobile device then compares the characteristics of the service provided by each of the access points 104, 108 and 112 and chooses an appropriate service based on these obtained characteristics, which most closely matches defined criteria. The mobile device then establishes a connection with the chosen access point.

When the user then travels to the position 100′, the user's mobile device obtains beacon signals from each of the access points 116 and 120. Using information from these beacon signals, the mobile device then obtains information regarding the access point and the characteristics of the service provided by each of the access points 116 and 120. From this obtained information, the mobile device then compares the characteristics of the service provided by each of the access points 116 and 120 and chooses an appropriate service based on these obtained characteristics, which most closely matches defined criteria. The mobile device then establishes a connection with the chosen access point.

Information about the access point and characteristics of the service provided by the access point is preferably obtained from out of band communications from the mobile device. The mobile device uses information received within the beacon signal to obtain this information about the access point. As discussed above, the beacon signal currently includes information from which the signal strength of the access point can be determined, the speeds at which the access point can communicate, the SSID and a MAC address.

In one embodiment of the present invention, a URL address is used by the access point as the entire SSID within the beacon signal. In this embodiment, when a mobile device receives the beacon signal, the SSID is parsed from the beacon signal and used as a URL address to connect with and obtain information from the information server corresponding to the access point. Using the URL address, the mobile device connects with the information server and obtains the information regarding the access point and the characteristics of service provided by the access point. This embodiment, has an advantage that it does not require any change to the format of the beacon signal. This embodiment will require that the SSID of an access point is programmed to be the appropriate URL address from where information regarding the access point is obtained. This embodiment has another advantage that there are not likely to be conflicts with the SSID as the URLs of different access points will have to be different. Each URL address associated with an access point will be required to be 32 bytes.

In another embodiment of the present invention, the access points are modified to send out a beacon signal with detailed information regarding the access point and the service provided by the access point. This embodiment requires a modification to the access point and to the beacon signal. Within the beacon signal, information such as available bandwidth, speed and cost are included within the beacon signal. The advantage of this embodiment, is that the mobile device receives all the necessary information within the beacon signal with which to make a connection decision and does not have to use a URL to obtain the information regarding the access point. A disadvantage of this embodiment, is that the beacon signals contain more data and will require more time and resources of the access point to send and the mobile device to receive.

In the preferred embodiment of the present invention, the format of the beacon signal is not modified. In the preferred embodiment, the SSID is split such that the first 16 octets of the SSID are a normal, ASCII renderable name and the final 16 octets represent an IPv6 address. In this preferred embodiment, when a mobile device receives the beacon signal, the SSID is parsed from the signal. The IPv6 address is then parsed from the SSID and used to obtain out of band information from the information server corresponding to the access point. Using the parsed IPv6 address, the mobile device connects with the information server and obtains information regarding the access point and the characteristics of service provided by the access point. This embodiment, also has the advantage that it does not require any change to the format of the beacon signal. This preferred embodiment will also require that the SSID of an access point is programmed to include the IPv6 address from where information regarding the access point is obtained.

Once the mobile device has obtained the information regarding each available access point and the characteristics of the service provided by the available access points, a network connection manager within the mobile device then compares the available access points and establishes a connection with the access point which most closely matches the criteria used by the network connection manager. The network connection manager keeps track, for the mobile device, of the available interfaces on the system, the different access points available to the wireless networks, the connectivity status of the networks and additional information such as the location of the device. The network connection manager also logs and tracks all of the networking activity of the applications on the mobile device. The network connection manager also matches all of the applications' connections to run over the appropriate network interfaces, as will be discussed in detail below.

Preferably, the network connection manager is run on the mobile device. In an alternative embodiment, in which a personal area network is used, linking a variety of smaller user devices such as cellular telephones, headsets and wearable computers, the network connection manager is run on a node of the personal area network, managing the network utilization and remote wireless connectivity for all of the devices within the personal area network.

The network connection manager examines all possible combinations of available access points that can be connected to each interface and determines the configuration that most closely matches certain criteria, either established by the user or specific to the mobile device. For example, the network connection manager can be set up to determine the connection configuration that will offer the most possible bandwidth that each connection can afford. In such a configuration, use of the connection with the most bandwidth available might also cost the most. In a second configuration, the network connection manager can be set up to choose the cheapest alternative above a certain minimum bandwidth rate. In another exemplary configuration, the network connection manager can be set up to choose the fastest alternative up to a certain cost amount and then use only the fastest free alternative, when the maximum cost amount has been reached. Preferably, the user also has the ability to change the criteria used by the network connection manager, at any time.

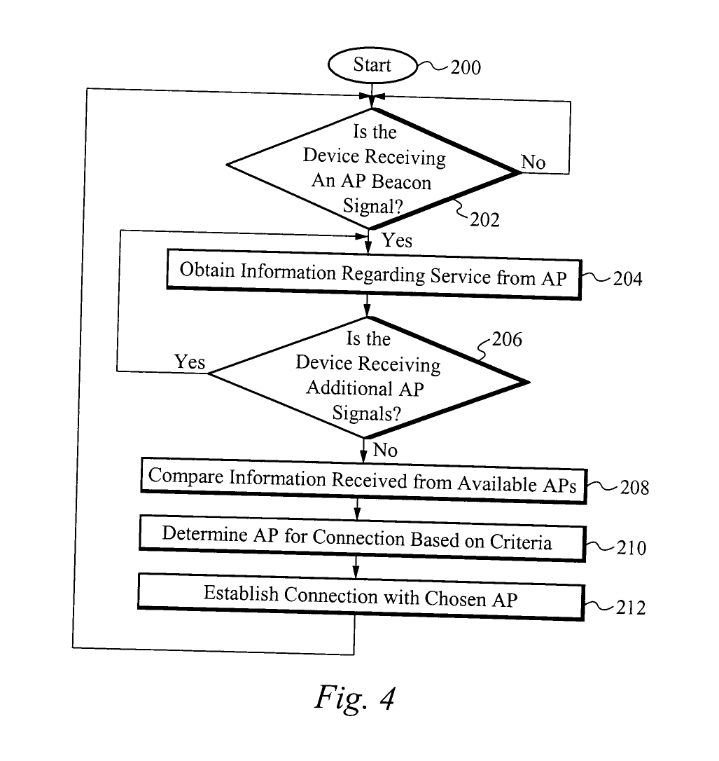

A flowchart of the method used by the mobile device of the preferred embodiment of the present invention to manage connectivity, is illustrated in FIG. 4. The method begins at the step 200. At the step 202, the device waits until it is receiving a beacon signal from an access point. When the device receives a beacon signal from an access point, information regarding the access point and the service available through the access point is obtained at the step 204. As discussed above, this information is either obtained from the beacon signal itself, or from an address included within the beacon signal. When the address is included within the beacon signal, the mobile device accesses the information server associated with the address and obtains the information regarding the access point and the service available through the access point. At the step 206, it is then determined if the mobile device is receiving beacon signals from any additional access points. If it is determined, at the step 206, that the mobile device is receiving beacon signals from additional access points, then the mobile device returns to the step 204 to obtain the information regarding the additional access points.

Once the information for all of the access points from which the mobile device is receiving signals has been obtained, then the network connection manager of the mobile device compares this information at the step 208. The network connection manager then determines the available access point that most closely matches the defined criteria at the step 210. At the step 212, a connection is then established with the available access point that most closely matches the defined criteria. The mobile device then returns to the step 202 to wait until additional beacon signals are received. Preferably, the mobile device continuously monitors and evaluates the available access points to ensure that the mobile device is always connected to the access point that most closely matches the established criteria.

Within the preferred embodiment of the present invention, separate IPv6 addresses are used for each application in order to maintain the use of appropriate interfaces for communications per application. For example, if video data and audio data are being sent by two different applications, it is desirable to be able to associate each different data flow with the appropriate interface, 802.11a for video and GPRS for audio. Accordingly, all packets sent from an application are sent with the specific IPv6 source address associated with that application. Each application preferably has a different associated IPv6 source address which is mapped to an appropriate interface. Similarly, any incoming packets are associated with the application corresponding to the destination address within the packets. One or more routing tables are used to track and maintain the source and destination addresses and ensure that outgoing packets are sent using the appropriate address for the application and incoming packets are associated with the application with the appropriate address.

When an outgoing packet is sent from the mobile device of the preferred embodiment of the present invention, the source address of the outgoing packet is obtained based on the application that generated the outgoing packet.

When an incoming packet is received by the mobile device of the preferred embodiment of the present invention, the destination address of the incoming packet is obtained. From this destination address, the appropriate application associated with the destination address is determined. The packet is then associated with the application associated with the destination address.

Preferably, the network connection manager of the present invention also utilizes a macromobility protocol that allows the applications to retain the same source address, even when the system moves and connects to new networks with different address ranges. This allows the applications to run continuously without any intervention as the system changes its network connectivity.

In a further alternative embodiment, separate addresses for each new network connection are maintained, so that the routing for each connection can be selectively changed in response to changing conditions.

Using different addresses for each application and retaining the same address through different connections, allows the network connection manager to bind an application to a particular interface and then seamlessly move that application from interface to interface as different wired and wireless network connections become available. With this flexibility, the user has the ability to tailor their usage to the available resources to achieve connectivity that meets desired criteria, such as the lowest possible cost or with the highest possible performance.

In operation, a mobile device obtains beacon signals from available access points. Using information within the beacon signals, the mobile device obtains information about the available access points and the services provided by the available access points. A network connection manager within the mobile device uses this obtained information to compare the characteristics of the access points and choose the access point which most closely matches defined criteria. A connection is then established with the access point which most closely matches the defined criteria. The network connection manager continuously monitors and evaluates the available access points to ensure that the mobile device is always connected to the access point that most closely matches the defined criteria.

The network connection manager also preferably uses different addresses for each application utilized by the mobile interface. This allows the network connection manager to bind an application to an interface and then move that application from interface to interface as different network connections become available.

Using the connectivity management system of the present invention, smooth or transparent transitioning between interfaces in response to various events is supported. As a user roams into a new area with different networks, the best or most advantageous connection can be selected. If the user becomes unsatisfied with the performance of an application or connection, the user has the ability to upgrade the performance of the application if choices are available. Based on the desired level of service and predefined criteria, the user's mobile device selects the access point and service that most closely matches the criteria, based on multiple characteristics such as cost, speed or power consumption.

It should be apparent to those skilled in the art that while the preferred embodiment of the connectivity management system of the present invention is directed to managing connections for mobile wireless devices, in alternative embodiments, the connectivity management is used to manage connections for wired devices as well. In such environments, the connectivity management system manages connections between different wired networks or between wired and wireless networks.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to those skilled in the art that while the preferred embodiment of the present invention utilizes accessibility over the internet, the present invention could also be accessible on any other appropriate communication structures, including intranets, direct connections and the like. Further, it will also be apparent to those skilled in the art that while the embodiment of the present invention chosen for illustration used IEEE 802.11b connections for communication, the present invention can also use any other appropriate communication standard or combination of communication standards, including any one or more current or future 802.11 standards.

1. A method of adaptively managing connectivity for a mobile device comprising:
a. obtaining a signal from each access point available to the mobile device, wherein the signal includes source information; and
b. obtaining characteristic information about each access point and characteristics of service provided by the access point using the source information.

2. The method as claimed in claim 1 wherein the signal is a beacon signal.

3. The method as claimed in claim 1 further comprising comparing the characteristic information to determine a preferred access point.

4. The method as claimed in claim 3 wherein the preferred access point is an access point which most closely matches criteria.

5. The method as claimed in claim 2 wherein the source information includes an address and is resident within an SSID of the beacon signal.

6. The method as claimed in claim 5 wherein the address is a URL address.

7. The method as claimed in claim 5 wherein the address is an IPv6 address.

8. The method as claimed in claim 1 wherein the source information includes the characteristic information.

9. The method as claimed in claim 1 further comprising associating a separate IPv6 address for communications relative to each separate application used by the mobile device.

10. The method as claimed in claim 1 further comprising associating a separate IPv6 address for communications relative to each separate application used with each separate connection by the mobile device.

11. The method as claimed in claim 1 wherein the characteristic information is obtained for an access point without forming a connection to the access point.

12. The method as claimed in claim 1 wherein an access point is available if the mobile device is within a range to communicate with the access point.

13. The method as claimed in claim 1 wherein the characteristics of service include one or more of bandwidth, speed and cost.

14. A method of adaptively managing connectivity for a mobile device comprising:
a. managing communications for the mobile device using a plurality of applications; and
b. associating a separate IPv6 address for communications relative to each separate application.

15. The method as claimed in claim 14 further comprising sending communications from the mobile device through one of a plurality of interfaces based on the separate IPv6 address and corresponding application.

16. The method as claimed in claim 14 further comprising receiving communications at the mobile device through one of a plurality of interfaces based on the separate IPv6 address and corresponding application.

17. The method as claimed in claim 14 further comprising:
a. obtaining a beacon signal from each access point available to the mobile device, wherein the beacon signal includes source information;
b. obtaining characteristic information about each access point and characteristics of service provided by the access point using the source information;
c. determining a preferred access point by comparing the characteristic information to criteria and determining the access point which most closely matches the criteria; and
d. establishing a connection with the preferred access point.

18. A method of adaptively managing connectivity for a mobile device comprising:
a. obtaining a beacon signal from each access point available to the mobile device, wherein the beacon signal includes source information;
b. obtaining characteristic information about each access point and characteristics of service provided by the access point using the source information; and
c. determining a preferred access point by comparing the characteristic information to criteria and determining the access point which most closely matches the criteria.

19. The method as claimed in claim 18 further comprising establishing a connection with the preferred access point.

20. The method as claimed in claim 19 wherein the connection is established using communications complying with an IEEE 802.11 standard.

21. The method as claimed in claim 18 wherein the source information includes an address and is resident within an SSID of the beacon signal.

22. The method as claimed in claim 21 wherein the address is a URL address.

23. The method as claimed in claim 21 wherein the address is an IPv6 address.

24. The method as claimed in claim 18 wherein the source information includes the characteristic information.

25. The method as claimed in claim 18 wherein an access point is available if the mobile device is within a range to communicate with the access point.

26. The method as claimed in claim 18 wherein the characteristics of service include one or more of bandwidth, speed and cost.

27. The method as claimed in claim 18 wherein the characteristic information is obtained for an access point without forming a connection to the access point.

28. The method as claimed in claim 18 further comprising associating a separate IPv6 address for communications relative to each separate application used by the mobile device.

29. The method as claimed in claim 18 further comprising associating a separate IPv6 address for communications relative to each separate application used with each separate connection by the mobile device.

30. A network connection manager configured to adaptively manage connectivity for a mobile device, the network connection manager comprising:
a. a communications interface configured to receive communications from access points available to the mobile device, the communications including a beacon signal from each available access point, wherein the beacon signal includes source information; and
b. a controller coupled to the communications interface to obtain characteristic information about each access point and characteristics of service provided by the access point using the source information.

31. The network connection manager as claimed in claim 30 wherein the controller compares the characteristic information to determine a preferred access point.

32. The network connection manager as claimed in claim 31 wherein the preferred access point is an access point which most closely matches criteria.

33. The network connection manager as claimed in claim 32 wherein the criteria is defined by a user.

34. The network connection manager as claimed in claim 30 wherein the source information includes an address and is resident within an SSID of the beacon signal.

35. The network connection manager as claimed in claim 34 wherein the address is a URL address.

36. The network connection manager as claimed in claim 34 wherein the address is an IPv6 address.

37. The network connection manager as claimed in claim 30 wherein the source information includes the characteristic information.

38. The network connection manager as claimed in claim 30 wherein the characteristic information is obtained for an access point without forming a connection to the access point.

39. The network connection manager as claimed in claim 30 wherein an access point is available if the mobile device is within a range to communicate with the access point.

40. The network connection manager as claimed in claim 30 wherein the characteristics of service include one or more of bandwidth, speed- and cost.

41. The network connection manager as claimed in claim 30 wherein the controller associates a separate IPv6 address for communications relative to each separate application used by the mobile device.

42. The network connection manager as claimed in claim 30 wherein the controller associates a separate IPv6 address for communications relative to each separate application used with each separate connection by the mobile device.

43. A network connection manager for adaptively managing connectivity for a mobile device comprising:
a. means for interfacing for receiving communications from access point available to the mobile device, the communications including a beacon signal from each available access point, wherein the beacon signal includes source information; and
b. means for controlling coupled to the means for interfacing for obtaining characteristic information about each access point and characteristics of service provided by the access point using the source information.

44. The network connection manager as claimed in claim 43 wherein the means for controlling compares the characteristic information to determine a preferred access point.

45. The network connection manager as claimed in claim 44 wherein the preferred access point is an access point which most closely matches criteria.

46. The network connection manager as claimed in claim 45 wherein the criteria is defined by a user.

47. The network connection manager as claimed in claim 43 wherein the source information includes an address and is resident within an SSID of the beacon signal.

48. The network connection manager as claimed in claim 47 wherein the address is a URL address.

49. The network connection manager as claimed in claim 47 wherein the address is an IPv6 address.

50. The network connection manager as claimed in claim 43 wherein the source information includes the characteristic information.

51. The network connection manager as claimed in claim 43 wherein the characteristic information is obtained for an access point without forming a connection to the access point.

52. The network connection manager as claimed in claim 43 wherein an access point is available if the mobile device is within a range to communicate with the access point.

53. The network connection manager as claimed in claim 43 wherein the characteristics of service include one or more of bandwidth, speed and cost.

54. The network connection manager as claimed in claim 43 wherein the means for controlling associates a separate IPv6 address for communications relative to each separate application used by the mobile device.

55. The network connection manager as claimed in claim 43 wherein the means for controlling associates a separate IPv6 address for communications relative to each separate application used with each separate connection by the mobile device.

56. A network connection manager configured to adaptively manage connectivity for a mobile device, the network connection manager comprising:
a. a plurality of interfaces each configured to send and receive communications for one of a plurality of applications used by the mobile device; and
b. a controller coupled to the plurality of interfaces to associate a separate IPv6 address for communications relative to each separate application, wherein only communications having an address corresponding to an application and a corresponding interface are sent and received through the interface.

57. A network of devices comprising:
a. a plurality of access points each including:
i. a wireless interface through which access point communications are sent and received including a beacon signal having source information; and
ii. a server interface configured to couple to one or more internet servers to provide internet communications with the servers for devices communicating through the wireless interface;
b. a mobile device configured to communicate with the wireless interface and including a network connection manager which adaptively manages connectivity for the mobile device, the network connection manager comprising:
i. a communications interface configured to receive the access point communications; and
ii. a controller coupled to the communications interface to obtain characteristic information about each access point available to the mobile device and characteristics of service provided by the access points using the source information.

58. The network of devices as claimed in claim 57 wherein the controller compares the characteristic information to determine a preferred access point.

59. The network of devices as claimed in claim 58 wherein the preferred access point is an access point which most closely matches criteria.

60. The network of devices as claimed in claim 59 wherein the criteria is defined by a user.

61. The network of devices as claimed in claim 57 wherein the source information includes an address and is resident within an SSID of the beacon signal.

62. The network of devices as claimed in claim 61 wherein the address is a URL address.

63. The network of devices as claimed in claim 61 wherein the address is an IPv6 address.

64. The network of devices as claimed in claim 57 wherein the source information includes the characteristic information.

65. The network of devices as claimed in claim 57 wherein the characteristic information is obtained for an access point without forming a connection to the access point.

66. The network of devices as claimed in claim 57 wherein an access point is available if the mobile device is within a range to communicate with the access point.

67. The network of devices as claimed in claim 57 wherein the characteristics of service include one or more of bandwidth, speed and cost.

68. The network of devices as claimed in claim 57 wherein the controller associates a separate IPv6 address for communications relative to each separate application used by the mobile device.

69. The network of devices as claimed in claim 57 wherein the controller associates a separate IPv6 address for communications relative to each separate application used with each separate connection by the mobile device.
